(19) United States
(12) Patent Application Publication
(10) Pub. No.: US 2010/0149532 A1
(43) Pub. Date: Jun. 17, 2010

(54) METHOD AND APPARATUS FOR OPTICAL MEASUREMENT

(76) Inventor: Naoji Moriya, Kyoto (JP)

Correspondence Address: Cheng Law Group, PLLC, 1100 17th Street, N.W., Suite 503, Washington, DC, 20036, US

(21) Appl. No.: 12/600,649

(22) PCT Filed: May 18, 2007
(86) PCT No.: PCT/JP2007/060271

§ 371 Date: Nov. 17, 2009

(51) Int. Cl. G01N 15/02; G01N 21/47

(52) U.S. Cl. 356/336; 356/337; 356/246; 356/441

(57) ABSTRACT

In the case of generating a diffraction grating resulting from the density distribution of particles by applying a spatially periodic electric field to a sample having particles dispersed movably in a medium, measuring diffracted light obtained by exposing the diffraction grating to a parallel light flux, and calculating the diffusion coefficient and/or size of the particles from the temporal change in the intensity of the diffracted light, the diffraction grating is exposed to multiple types of parallel light fluxes having mutually different wavelengths simultaneously or sequentially, the diffracted light is measured separately for each wavelength, and the measurement results are used selectively for calculation of the diffusion coefficient and/or size of the particles, and whereby the measurement can be carried out accurately without being affected by a plasmon resonance phenomenon even for metal particles.

### TECHNICAL FIELD

The present invention relates to a method and apparatus for optically measuring information about the diffusion of particles in a sample in which the particles are dispersed movably in a medium and information about the particle size, the viscosity of the medium, and/or the migration of the particles and, in particular, to a method and apparatus for forming a periodic electric field distribution in a sample in which particles are dispersed movably in a medium to generate a diffraction grating resulting from the density distribution of the particles and measuring information about the diffusion of the particles and information about the particle size, the viscosity of the medium, and/or the migration of the particles based on the temporal change of diffracted light from the diffraction grating.

### BACKGROUND ART

Particles with a diameter of 100 nm or less are generally called nanoparticles, and are just beginning to be used in various fields because they have properties different from those of general bulk materials of even the same material. Various methods for measuring particle size have been known including the laser diffraction/scattering method. Among them, methods based on the so-called dynamic scattering method (photon correlation method) have been employed mainly for nanoparticles with a diameter of 100 nm or less (refer to Patent Literatures 1 and 2 for example).

The dynamic scattering method utilizes the Brownian motion of particles, including exposing particles performing a Brownian motion in a medium to a light beam, measuring the intensity of scattered light from the particles at a predetermined position, and capturing the fluctuation of the scattered light intensity caused by the Brownian motion of the particles, that is, the temporal change of the scattered light. That is, the method utilizes the fact that to-be-measured particles each perform a Brownian motion with intensity according to its particle size to thereby calculate the particle size distribution of the particles.

However, in the dynamic scattering method (photon correlation method), in which the fluctuation of scattered light from particles is measured, the fluctuation of scattered light to be measured is imperceptible in the case of microparticles because the intensity of scattered light from microparticles is proportional to the fifth to sixth power of the particle size. Due to its principle, the problems of poor measurement sensitivity as well as poor S/N cannot be avoided.

As a powerful approach for solving such unavoidable problems in the dynamic scattering method, there has been proposed a method and apparatus for electrophoresing particles dispersed movably in a medium by applying a spatially periodic electric field to the particles, generating a quasi diffraction grating by making the particles have a spatially periodic alteration in concentration, in this state detecting diffracted light obtained by exposing the particles to a collimated light flux such as a laser beam, and thereby calculating the diffusion coefficient and size of the particles from the temporal change of the diffracted light after stopping the application of the electric field (refer to Patent Literature 3 and 4).

This proposed method and apparatus utilizes dielectrophoresis or electrophoresis of particles in a medium, including generating a diffraction grating resulting from the concentration distribution (density distribution) of the particles by applying an electric field and, in this state, annihilating the diffraction grating by stopping the application of the electric field, that is, utilizes the fact that the extinction process depends on the diffusion coefficient of the particles. The diffusion coefficient and therefore the size of the particles can be calculated from the time required for dissipation of diffracted light from the diffraction grating generated from the density distribution of the particles.

In accordance with this proposed method and apparatus, the intensity of diffracted light from the diffraction grating resulting from the concentration distribution of particles is detected, and thus the intensity is greater than that of scattered light from particles obtained in the dynamic scattering method, thereby a more intense signal is to be measured, resulting in a significant improvement in S/N and sensitivity relative to the dynamic scattering method.

Patent Literature 1: U.S. Pat. No. 5,094,532

Patent Literature 2: Japanese Patent Laid-Open Publication No. 2001-159595

Patent Literature 3: Japanese Patent Laid-Open Publication No. 2006-84207

Patent Literature 4: WO/2007/010639

### DISCLOSURE OF THE INVENTION

### Problems to be Solved by the Invention

Meanwhile, in the measuring method and apparatus disclosed in Patent Literatures 3 and 4, since the greater the phase difference of the diffraction grating formed by the density modulation of particles, the higher the sensitivity, it is desirable to use a shorter-wavelength light source as long as it does not arouse concern over scattering as a light source for a collimated light flux to be applied to the diffraction grating to measure the temporal change in the intensity of diffracted light from the diffraction grating.

However, if the sample including the medium and particles has a large absorption coefficient with respect to the wavelength of the collimated light flux applied to the diffraction grating for generation of diffracted light, the intensity of the applied collimated light flux decreases significantly to be unmeasurable while transmitting the sample.

Metals are general absorbent substances and show a strong absorption feature from the visible to near-infrared range by the surface plasmon resonance effect if the particle size is smaller than the wavelength. The absorption peak wavelength and absorbance depend on the particle size and the like. Therefore, when measuring the intensity of diffracted light using a collimated light flux of a single wavelength, no diffracted light can be observed because the sample in the vessel absorbs light severely depending on the particle size.

There is also another problem in that in the process of applying a periodic electric field to the sample in the cuvette to attract particles and then stopping or modulating the application of the electric field to turn to diffusion, when a change in the intensity of diffracted light caused by the non-linear change in the absorption coefficient occurs due to a plasmon resonance phenomenon which may occur if the distance between metal particles is about several tens nm or less, the diffusion coefficient of the particles and other features cannot be calculated accurately if there is no information about the non-linear change in the absorption coefficient.

The present invention has been made to solve the above-described problems, and an object thereof is to provide a method and apparatus for optical measurement whereby the diffusion coefficient and particle size (Stokes diameter), the viscosity of the medium, and/or the attracting force operating on particles can be measured accurately even for microparticles to which a plasmon resonance phenomenon may occur, in particular, for metal microparticles.

### Means for Solving the Problems

The present invention is directed to a method for optical measurement including: applying a spatially periodic electric field to a sample having particles dispersed movably in a medium to cause a attracting force to operate on the particles; generating a diffraction grating resulting from the density distribution of the particles in the medium; detecting the varying intensity of diffracted light generated by irradiation to the diffraction grating with a collimated light flux; and evaluating the characteristics of the particles and/or medium based on the temporal change in the intensity of diffracted light in the process of generation or relaxation of the diffraction grating through the application of the electric field or the stopping or modulation of the electric field, in which the diffraction grating resulting from the density distribution of the particles is exposed to multiple collimated light fluxes having mutually different wavelengths for the same sample, the varying intensity of diffracted light is detected separately for each of the collimated light fluxes of the respective wavelengths, and the detection results are used selectively to evaluate the characteristics of the particles and/or medium.

The present invention solves the above-described problems by exposing the sample to multiple collimated light fluxes having different wavelengths simultaneously or sequentially, detecting diffracted light generated when the light of the respective wavelengths transmits through the diffraction grating composed of the particles, and selectively using diffracted light by collimated light fluxes of a wavelength range within which the optical absorption by to-be-measured particles is not more than necessary to make available for evaluation.

That is, if multiple collimated light fluxes having different wavelengths are applied to the same sample and diffracted light from the diffraction grating resulting from the density distribution of the particles is detected, selectively using detection results not affected by optical absorption by the surface plasmon resonance effect that may occur depending on the relationship between the size of metal particles or distances with each particle, and the wavelength allows the temporal change of generation and extinction of the diffraction grating to be observed accurately.

Also, using at least two collimated light fluxes having their respective wavelengths different by 100 nm or so from each other allows a plasmon resonance phenomenon not to occur in principle in at least one wavelength in the same diffusion time region. Complementing the change of diffracted light in the two wavelengths allows the rate of diffusion and the like to be analyzed without being affected by the non-linear change in the absorption coefficient associated with plasmon resonance.

The method for illuminating multiple collimated light fluxes having mutually different wavelengths to the same sample may be achieved by either irradiating the collimated light fluxes simultaneously on the same optical axis and detecting diffracted light at mutually different positions (second aspect) or irradiating the collimated light fluxes sequentially at time intervals and detecting diffracted light (third aspect).

Information obtained from the temporal change of diffracted light may include information about the diffusion coefficient and size (Stokes diameter) of the particles obtained from the temporal change of diffracted light in the process of extinction of the diffraction grating (fourth aspect), information about the diffusion (e.g. dielectrophoretic force) of the particles obtained from the temporal change of diffracted light in the process of generation of the diffraction grating (fifth aspect), or information about the viscosity of the medium (liquid) obtained from the temporal change of diffracted light in the process of extinction of the diffraction grating with the particle size of the particles being given (sixth aspect).

Further, in the present invention, if the detection of the diffracted light is preceded by illuminating multiple collimated light fluxes having different wavelengths to the particles being dispersed in the medium and measuring the transmittance thereof and obtaining a wavelength range suitable for detection of the diffracted light from the measurement result, and then multiple collimated light fluxes within the obtained wavelength range are used for actual detection of the diffracted light (seventh aspect), collimated light fluxes of a wavelength range within which the optical absorption is increased due to the surface plasmon resonance effect that depends on the particle size are avoided to be used for detection of diffracted light and thereby the waste of measuring operations can be prevented from occurring.

An apparatus for optical measurement according to the present invention is for implementing the foregoing method for optical measurement, and a ninth aspect of the present invention is for implementing the method according to the second aspect of the present invention, providing an apparatus for optical measurement including: a cuvette for storing therein a sample having particles dispersed movably in a medium; a power source for generating an AC or DC voltage; an electrode pair adapted to generate a spatially periodic electric field in the cuvette the application of the voltage from the power source; an irradiation optical system for irradiating a collimated light flux to a diffraction grating resulting from the density distribution of the particles generated in the cuvette through the application of the voltage; a detection optical system for detecting diffracted light generated by the parallel light flux transmitting through the diffraction grating; voltage control means for applying the voltage from the power source to the electrode pair and stopping or modulating the application of the voltage to generate and annihilate the diffraction grating resulting from the density distribution of the particles in the cuvette; and data processing means for retrieving outputs from the detection optical system to evaluate the characteristics of the particles and/or medium, in which the irradiation optical system is adapted to selectively radiate multiple collimated light fluxes having mutually different wavelength ranges and the data processing means is adapted to retrieve detection outputs of diffracted light from the diffraction grating by the collimated light fluxes of the respective wavelength ranges.

The irradiation optical system for illuminating collimated light fluxes having different wavelengths to the sample may include: multiple lasers or LEDs for radiating, respectively, monochromatic light having mutually different wavelengths; and a collimation optical system for shaping the radiated light from the light sources into a collimated light flux (tenth aspect), or may include: a light source for radiating light having a wide wavelength range; a wavelength selection optical system for selectively extracting multiple monochromatic lights having mutually different wavelengths from the radiated light from the light source using a wavelength-dispersive spectroscope or multiple selectable interference filters; and a collimation optical system for shaping the extracted monochromatic light into a collimated light flux (eleventh aspect).

A twelfth aspect of the present invention is for implementing the method according to the third aspect of the present invention, providing an apparatus for optical measurement including: a cuvette for storing therein a sample having particles dispersed movably in a medium; a power source for generating an AC or DC voltage; an electrode pair adapted to generate a spatially periodic electric field in the cuvette through the application of the voltage from the power source; an irradiation optical system for illuminating a collimated light flux to a diffraction grating resulting from the density distribution of the particles generated in the cuvette through the application of the voltage; a detection optical system for detecting diffracted light generated by the collimated light flux transmitting through the diffraction grating; voltage control means for applying the voltage from the power source to the electrode pair and stopping or modulating the application of the voltage to generate and extinction the diffraction grating resulting from the density distribution of the particles in the cuvette; and data processing means for retrieving outputs from the detection optical system to evaluate the characteristics of the particles and/or medium, in which the irradiation optical system is adapted to simultaneously radiate multiple collimated light fluxes having mutually different wavelength ranges, the detection optical system is adapted to simultaneously and separately detect diffracted light appearing at different angles when the collimated light fluxes transmit through the diffraction grating, and the data processing means is adapted to retrieve detection outputs of the diffracted light by the detection optical system.

In the arrangement above, the irradiation optical system for the case of employing the method for illuminating multiple collimated light fluxes simultaneously to the same sample on the same optical axis may include: multiple lasers or LEDs for radiating, respectively, monochromatic light having mutually different wavelengths; an optical system for combining light fluxes from the light sources on an optical path; and a collimation optical system for shaping the combined light into a collimated light flux (thirteenth aspect), or may include: an LED having multiple emission spectra; and a collimation optical system for shaping output light from the LED into a collimated light flux (fourteenth aspect). Further, the irradiation optical system may include: a light source for radiating light having a wide wavelength range; and a collimation optical system for shaping the radiated light from the light source into a collimated light flux, and the detection optical system may be arranged in such a manner that the disposed positions of a plurality of light detectors and/or the position of a field-limiting mask for each light detector can be adjusted so that diffracted light having the respective wavelength components from the diffraction grating resulting from the density distribution of the particles is received at mutually different angles (fifteenth aspect).

In order to illuminate multiple collimated light fluxes having different wavelengths to the particles being dispersed in the medium to measure the transmittance thereof and determine a wavelength range suitable for detection of the diffracted light before the detection of the diffracted light, the apparatus may further include: means for measuring the transmittance of light of the respective wavelengths through the sample; and means for automatically determining, based on the measurement results and a preliminarily stored database, for example, that light of wavelengths with a lower transmittance is not used for actual measurement of the diffracted light (seventeenth aspect).

### BRIEF DESCRIPTION OF THE DRAWINGS

FIG. 1 shows an overall configuration according to an embodiment of the present invention, including a schematic diagram showing an optical configuration and a block diagram showing an electrical configuration;

FIG. 2 shows a pattern example of an electrode pair arranged in a sample cuvette in FIG. 1;

FIG. 3 is a graph showing an example of a voltage waveform applied to the electrode pair and an example of the temporal change in the intensity of diffracted light from a diffraction grating resulting from the density distribution of particles in the embodiment of the present invention;

FIG. 4 is a graph showing the relationship between the particle size and the absorption coefficient of gold colloids;

FIG. 5 is a schematic diagram showing the configuration of an irradiation optical system according to another embodiment of the present invention;

FIG. 6 is a schematic diagram showing the configuration of a detection optical system according to still another embodiment of the present invention; and

FIG. 7 is a schematic diagram showing the configuration of an irradiation optical system according to a further embodiment of the present invention.

### REFERENCE NUMERALS

1 Sample cuvette
2 Electrode pair
21, 22 Electrodes
21a, 22a Electrode pieces
21b, 22b Connection parts
3 Power source
4 Irradiation optical system
41, 42 Diode lasers
43 Beam mixer
5 Detection optical system
51 Condenser lens
52, 53 Light detectors
6 Data processing and control section
P High-density areas of particles

### BEST MODE FOR CARRYING OUT THE INVENTION

Embodiments of the present invention will hereinafter be described with reference to the accompanying drawings.

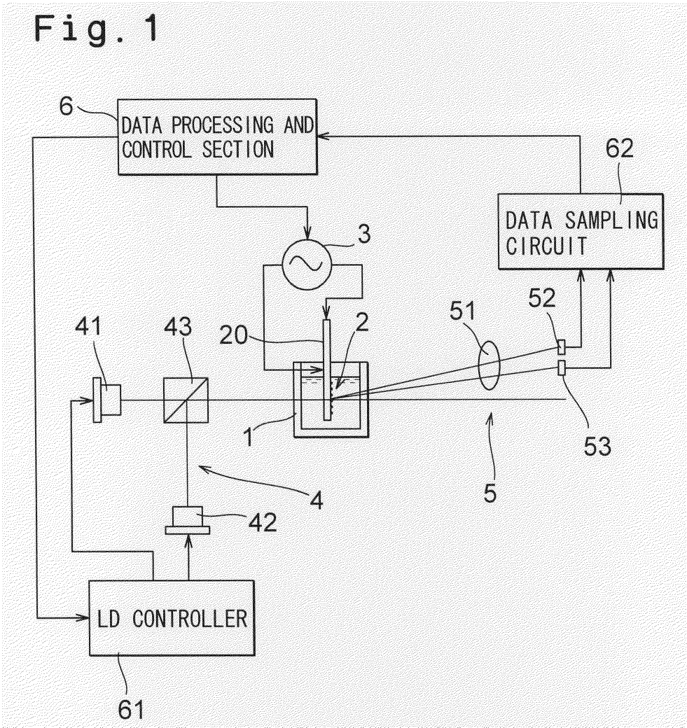

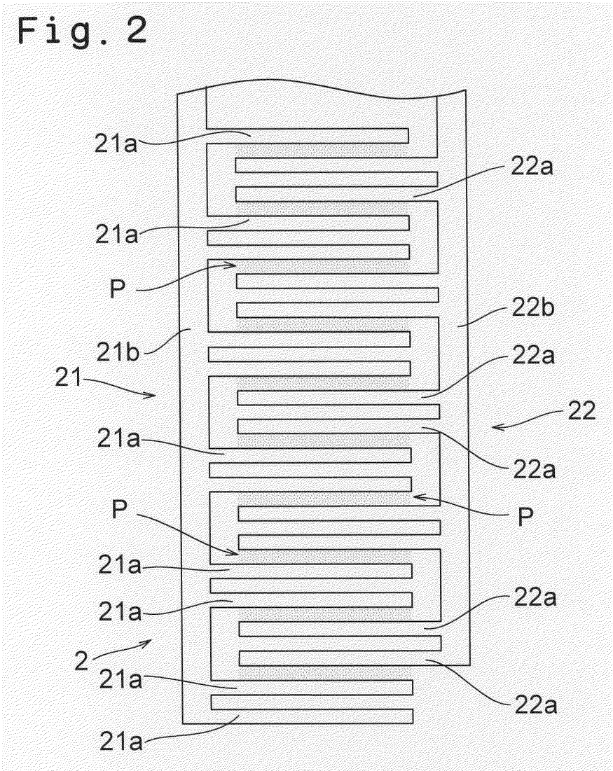

FIG. 1 shows an overall configuration according to an embodiment of the present invention. FIG. 2 shows a pattern example of an electrode pair 2 arranged in a sample cuvette 1.

The apparatus includes mainly: a sample cuvette 1 for storing a sample having particles dispersed movably in a medium, for example, a sample having particles dispersed in a liquid, or a sample composed of a gel having particles dispersed movably therein; an electrode power source 3 for applying a voltage to an electrode pair 2 provided in the sample cuvette 1; an irradiation optical system 4 for illuminating light to the sample cuvette 1; a detection optical system 5 for measuring diffracted light from a diffraction grating resulting from the density distribution of the particles generated in the sample cuvette 1 through the application of a voltage to the electrode pair 2; and a data processing and control section 6 for collecting outputs from the detection optical system 5 to perform various analyses as well as for controlling the measuring operations of the apparatus.

The sample cuvette 1 is composed of a transparent material such as glass, in which a plate-like member 20 also composed of a transparent material is arrange fixedly, and the electrode pair 2 is formed on the surface of the plate-like member 20.

As shown in FIG. 2, the electrode pair 2 includes comb-like electrodes 21 and 22, and the electrodes 21 and 22 have multiple mutually parallel linear electrode pieces 21a . . . 21a and 22a . . . 22a and connection parts 21b and 22b electrically connecting the respective electrode pieces 21a . . . 21a and 22a . . . 22a to each other, respectively.

The electrodes 21 and 22 each have a shape in which electrode piece unevenly-arranged areas including two linear electrode pieces 21a or 22a arranged adjacently to each other and electrode piece absent areas with no electrode piece arranged therein are formed alternately. Then, two electrode pieces 21a or 22a in each electrode piece unevenly-arranged area of one electrode are fitted into each electrode piece absent area of the other and, as a whole, the electrode pieces 21a and 22a are arranged alternately two by two in parallel with each other at regular intervals.

When a voltage is applied from the power source 3 to the electrode pair 2, an electric field distribution is generated in the sample stored in the cell 1, and the particles in the sample are attracted due to the field distribution as will be described hereinafter, thereby a diffraction grating resulting from the density distribution of the particles is generated. In this example, the power source 3 is an AC power source, and the particles are moved by the dielectrophoretic force.

The irradiation optical system 4 includes two diode lasers 41 and 42 for radiating laser beams having mutually different wavelengths, a beam mixer 43 for combining radiated light from the diode lasers 41 and 42 on the same optical path, and a collimation optical system composed of lenses (not shown in the drawing) that are arranged appropriately to finally shape the combined radiated light from the laser diodes 41 and 42 into collimated light fluxes. The first diode laser 41 radiates light having a wavelength of 635 nm, and the second diode laser 42 radiates light having a wavelength of 785 nm. The diode lasers 41 and 42 are driven and controlled by an diode laser controller 61 provided under the control of the data processing and control section 6.

The detection optical system 5 includes a condenser lens 51 and two light detectors 52 and 53 provided at mutually different positions corresponding to the collimated light fluxes of the two respective wavelengths to detect diffracted light from a diffraction grating resulting from the density distribution of particles formed in the sample cuvette 1 by exposing the sample in the sample cuvette 1 to the collimated light fluxes from the irradiation optical system 4. That is, since the collimated light fluxes radiated from the irradiation optical system 4 are a combination of light of two wavelengths as mentioned above, diffracted light from the diffraction grating appears in different directions depending on the respective wavelengths. The two diode lasers 52 and 53 are arranged, respectively, in directions corresponding to the diffracted light by the collimated light fluxes of the respective wavelengths, and using them, the diffracted light by the collimated light fluxes of the respective wavelengths is detected separately. Outputs from the light detectors 52 and 53 are retrieved constantly into the data processing and control section 6 through a data sampling circuit 62 including mainly an amplifier and an A/D converter.

In the above-described arrangement, when an AC voltage from the power source 3 is applied to between the electrodes 21 and 22 constituting the electrode pair 2, an electric field distribution according to the electrode pattern is formed within the sample cuvette 1, and a density distribution of the particles is caused by dielectrophoresis based on the field distribution. That is, in the electrode pattern shown in FIG. 2, high-density areas P of particles are formed in a part where electrode pieces of reverse polarities are adjacent to each other, or in a part where the electrode pieces 21a of one electrode are adjacent to the electrode pieces 22a of the other electrode 22 as shown in the drawing. The high-density areas P of particles are formed in a spatially repeated manner at the pitch which is twice the arrangement pitch of the electrode piece 21a or 22a, and in parallel with the electrode pieces 21a and 22a. And a diffraction grating is formed by the multiple high-density areas P of particles. When the application of the voltage to the electrode pair 2 is stopped in the state where the diffraction grating exists, the particles start to be diffused and thereby the spatial density of the particles in the sample becomes uniform, and accordingly the diffraction grating resulting from the density distribution of the particles is annihilated in due course.

When the collimated light fluxes from the irradiation optical system 4 are applied to the diffraction grating resulting from the density distribution of particles, the light is diffracted by the diffraction grating. In the electrode pattern shown in FIG. 2, the diffraction grating resulting from the density distribution of particles has a grating pitch twice as large as that of the diffraction grating formed by the electrode pieces 21a and 22a, so that the grating constants are different between the diffraction gratings. Therefore, since diffracted light from the diffraction grating resulting from the density distribution of particles and diffracted light from the diffraction grating formed by the electrode pieces 21a and 22a appear in their respective different directions, diffracted light from the diffraction grating resulting from the density distribution of particles can only be detected by arranging the light detectors 52 and 53 at required positions.

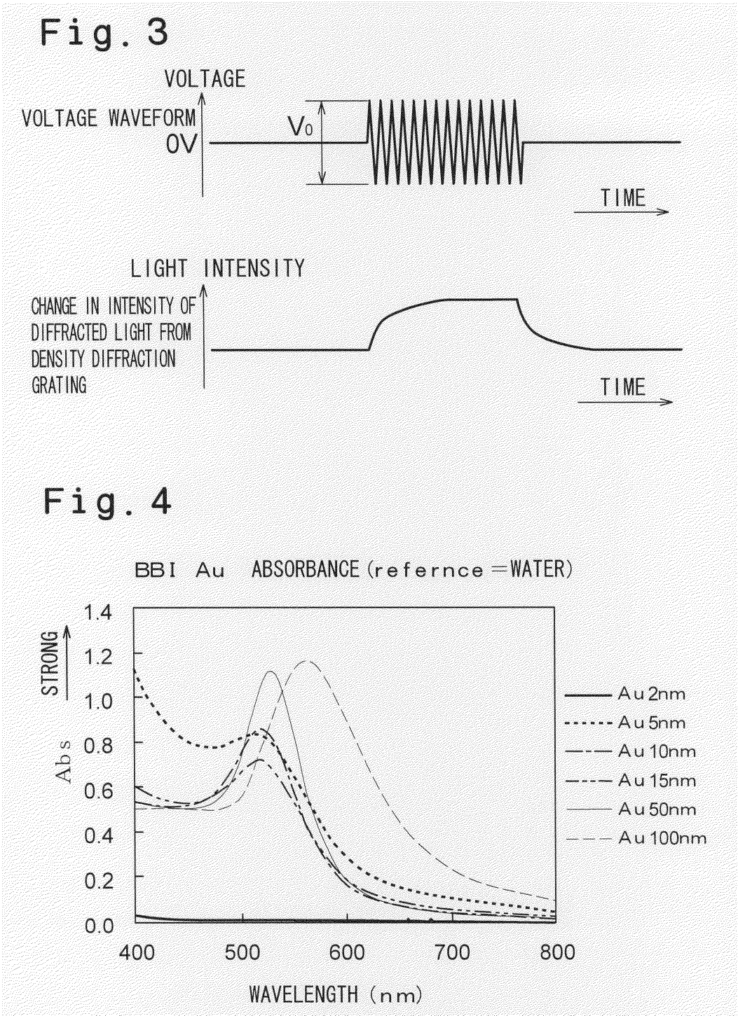

The intensity of the thus detected diffracted light from the diffraction grating resulting from the density distribution of particles decreases gradually during the process of extinction of the diffraction grating. FIG. 3 is a graph showing an example of a voltage waveform applied to the electrode pair 2 and an example of the temporal change in the intensity of diffracted light from the diffraction grating resulting from the density distribution of particles. These examples show the case where a constant sinusoidal AC voltage V₀ is applied to the electrode pair 2 to cause a dielectrophoretic force to operate on the particles.

The graph of the diffracted light intensity shown in FIG. 3 is for the case no plasmon resonance occurs on the particles, where the rate of increase in the intensity of diffracted light while the electric field is applied depends on the intensity of the dielectrophoretic force of the particles in the sample, while the rate of reduction in the intensity of diffracted light after stopping the application of the electric field depends on the diffusion coefficient of the particles in the sample. However, in the case of metal nanoparticles, for example, the change in the intensity of diffracted light is affected by a plasmon resonance phenomenon depending on the particle size or interparticle distance and the wavelength of a collimated light flux to be applied, and therefore may not represent only the state of collection and distribution of the particles.

In the case of measuring gold colloids, for example, the plasmon resonance condition and therefore the absorption coefficient depend on the particle size as shown in FIG. 4. Therefore, if a collimated light flux having a wavelength of only 635 nm is applied with the emphasis on the sensitivity to transparent substances, and if the particle size is several tens nm or more, there occurs a problem in that no signal can be obtained because the absorbance of such particles is high.

Furthermore, the plasmon resonance condition and therefore the absorption coefficient vary due to overcrowding of particles caused by dielectrophoresis. On the other hand, when the dielectrophoresis is stopped, the interparticle distance increases with the free diffusion of particles, which causes a shift of the resonant wavelength to finally result in an extinction of the resonance, and whereby the absorption coefficient varies constantly at the beginning of the diffusion. It is therefore impossible, as long as measuring with a single wavelength, to determine whether the temporal change in the intensity of diffracted light under measurement is caused by the relaxation of the density modulation of particles due to the diffusion or by the effective change in the absorption coefficient due to the change in the plasmon resonance condition.

In the embodiment shown in FIG. 1, since collimated light fluxes having their respective different wavelengths (two wavelengths in this embodiment) are used and the intensity of diffracted light is measured for each of the collimated light fluxes of the respective wavelengths, it can be determined, within the time region having different diffracted light attenuation characteristics for the respective wavelengths, that the signal change is caused by the change in the plasmon resonance condition.

That is, the intensity of diffracted light from the diffraction grating resulting from the density distribution of the particles attenuates due to diffusion over time after stopping the application of the electric field. The attenuation process is represented by the following approximation (1).

$$\begin{matrix}[ Mathematical Expression 1 ] & \\ I ∝ {I}_{0} exp [ - 2 {( \frac{2 π}{Λ} )}^{2} Dt ] & ( 1 )\end{matrix}$$

In the expression (1), I₀ represents the diffracted light intensity when the voltage application is stopped, “t” represents the elapsed time after stopping the voltage application, I represents the diffracted light intensity after the elapsed time “t”, Λ represents the grating pitch of the diffraction grating resulting from the density distribution of particles, and D represents the diffusion coefficient.

That is, the attenuation rate of diffracted light in the process of extinction of the diffraction grating is represented by an exponential having a single attenuation coefficient regardless of the wavelength of the collimated light flux as long as the particle size is unitary and thereby the refractive index and absorption coefficient are constant. In a broader sense, in the case of variously sized particles, the attenuation coefficient is not unitary, but if the refractive index and absorption coefficient are constant, the diffracted light shows the same attenuation profile even if may be measured using parallel light fluxes having mutually different wavelengths.

In the case of metal nanoparticles, plasmon resonance occurs under different conditions depending on the particle size, as shown in FIG. 4, as well as on the particle shape, such as sphere or cylinder, and the absorption peak wavelength varies.

If the particles are overcrowded to be close to the order of wavelength, these multiple particles mutually affect each other, and thus the plasmon absorption characteristics, that is, the absorption rate at each wavelength may vary. Therefore, different plasmon resonance occurs with the relaxation of the overcrowding of particles, which may be viewed as behaving as if the absorption coefficient varies with the progression of the diffusion even if the intensity of diffracted light may be observed at a specific wavelength.

Consequently, as long as diffracted light by parallel light fluxes of two wavelengths is observed, and if the diffracted light is within the same time region (e.g. 0.5 to 3 sec. after the start of diffusion) and the diffracted light intensity has the same attenuation profile, the measurement results by the two wavelengths include no variation of plasmon resonance and the data within the time region, which reflects only the size distribution of the particles, can be made available for analysis of the particle size distribution.

Meanwhile, if the diffracted light intensity has a different attenuation profile within the same time region (e.g. 0.5 sec. after the start of diffusion), at least one of the results by the two wavelengths includes a variation of plasmon resonance and it can be determined that the data within the time region, which does not reflect only the size distribution of the particles, cannot be made available for analysis of the particle size distribution.

Based on the determination above, the data processing and control section 6 uses the change in the intensity of diffracted light determined not to be affected by a plasmon resonance phenomenon to evaluate the diffusion coefficient of the particles, the particle size, or the viscosity of the medium liquid.

That is, the diffusion coefficient can be obtained by calculating D in the expression (1), and the particle size can be obtained by the following expression (2) using the diffusion coefficient D.

$$\begin{matrix}[ Mathematical Expression 2 ] & \\ D = \frac{{k}_{B} T}{3 πη d} & ( 2 )\end{matrix}$$

In the expression (2), “d” represents the particle size, “η” represents the viscosity of the medium liquid having particles dispersed therein, k_{B} is the Boltzmann constant, and T represents thermodynamic temperature. Using particles with a given particle size “d”, the viscosity “η” of the medium liquid can be obtained by the expressions (1) and (2).

Further, the magnitude of the dielectrophoretic force operating on the particles can be evaluated from the rate of increase in the intensity of diffracted light in the process of generation of the diffraction grating.

Although the above-described embodiment shows the case where the intensity of diffracted light by collimated light fluxes of two wavelengths is measured, measuring the intensity of diffracted light by collimated light fluxes of three or more wavelengths allows for handling of a wider size range of metal particles. In addition, if the temporal change profiles in the measurement results by at least two wavelengths are the same among the measurement results of the intensity of diffracted light by collimated light fluxes of three or more wavelengths, the data can be determined not to be affected by plasmon resonance, and whereby the determination can be facilitated.

It is also useful to provide a light source for radiating light having a wavelength of 635 nm or less to achieve a higher sensitivity for microp articles that do not arouse concern over scattering.

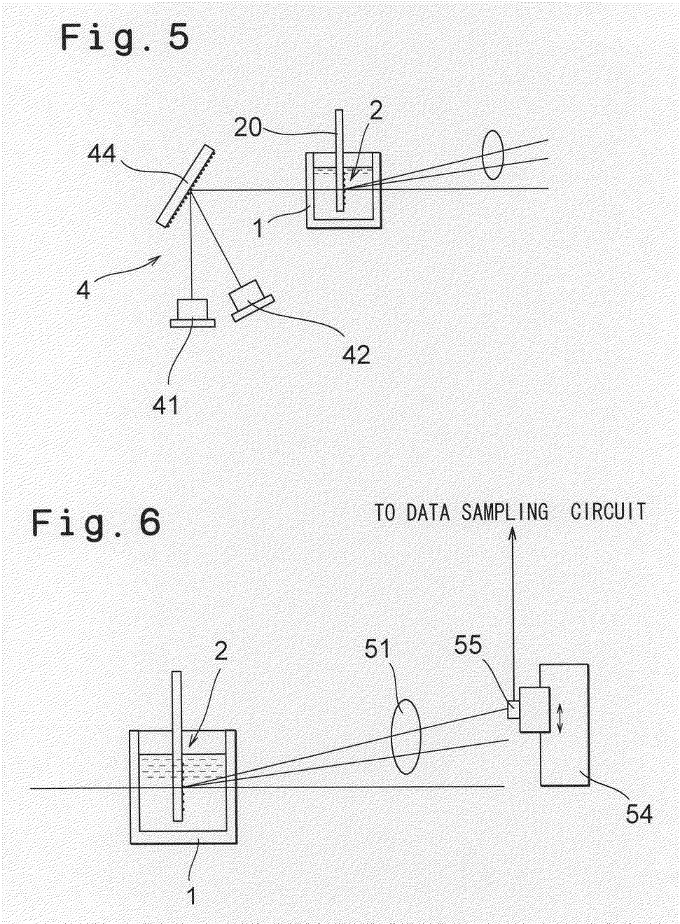

Instead of the beam mixer 43 in the irradiation optical system 4 according to the above-described embodiment, a diffraction grating 44 may be used to guide radiated light from the diode lasers 41 and 42 on the same optical path, the substantial configuration of which is schematically shown in FIG. 5.

Also, it may be arranged that multiple elements for radiating monochromatic light such as diode lasers may be arranged as the irradiation optical system 4, and the elements are driven selectively one by one to illuminate a collimated light flux to the sample cuvette 1. In this case, the detection optical system 5 may include: a stage 54 adapted to move linearly in the dispersion direction of diffracted light within a plane perpendicular to the optical axis of the irradiation optical system 4; and a single light detector 55 arranged on the stage 54, as shown in FIG. 6, in which the light detector 55 is positioned by driving the stage 54 in accordance with the diffraction angle that varies depending on the wavelength of a selected collimated light flux. This arrangement is useful in avoiding the difficulty, in the case the wavelength difference between multiple collimated light fluxes selected in the irradiation optical system 4 is small, that the diffraction angle difference is also small and therefore it is hard to detect the diffracted light fluxes with different detectors.

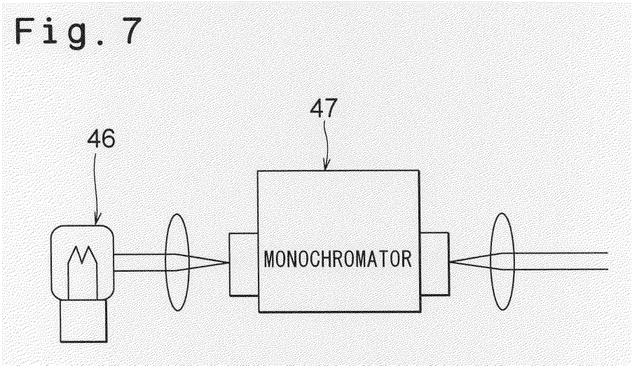

Further, as schematically shown in FIG. 7, a white light source 46 such as a halogen lamp or a broadband light source such as an AES light source may be employed as the light source in the irradiation optical system 4, and a monochromator 47 may be combined with the light source. In this case, collimated light fluxes of arbitrary wavelengths can be applied to the sample cuvette 1. However, it is useful in view of measurement convenience to use discrete wavelengths set at certain intervals and to fixedly arrange different detectors for the respective wavelengths.

Although the above-described embodiments show the case where an AC voltage is applied to the electrode pair 2 to trap particles and thereby generate a diffraction grating and thereafter the application of the AC voltage is stopped to diffuse the particles, the applied AC voltage may be modulated after the generation of the diffraction grating to diffuse the particles.

Furthermore, information about the diffusion coefficient and/or size of the particles or the viscosity of the medium liquid can be obtained even if a DC voltage may be applied to the electrode pair 2 to electrophorese particles and thereby generate a diffraction grating, and thereafter the application of the voltage may be stopped to start the diffusion of the particles.

Also, in the above-described embodiments, it is useful in view of measurement efficiency, before attraction the particles to generate a diffraction grating, to be illuminated with multiple collimated light fluxes having mutually different wavelengths and measure the transmittance thereof, with the particles being dispersed in the medium, and then to determine a wavelength range suitable for detection of the diffracted light. In this case, it is preferable to measure and store the transmittance of light of the respective wavelengths through the sample, and based on the measurement results and a preliminarily stored database, to exclude light of wavelengths with a lower transmittance, for example, for actual measurement of the diffracted light, and whereby the trouble of having to use light of unnecessary wavelengths can be avoided.

### INDUSTRIAL APPLICABILITY

In accordance with the method and apparatus according to the present invention, the diffusion coefficient and/or particle sizes or the magnitude of a attracting force can be measured accurately without being affected by a plasmon resonance phenomenon, even for particles on which such a phenomenon can occur, such as metal nanoparticles.

1. A method for optical measurement comprising: applying a spatially periodic electric field to a sample having particles dispersed movably in a medium to cause a attracting force to operate on the particles; generating a diffraction grating resulting from the density distribution of the particles in the medium; detecting the varying intensity of diffracted light generated by exposing the diffraction grating to a collimated light flux; and evaluating the characteristics of the particles and/or medium based on the temporal change in the intensity of diffracted light in the process of generation or extinction of the diffraction grating through the application of the electric field or the stopping or modulation of the application, wherein
the diffraction grating resulting from the density distribution of the particles is illuminated to multiple collimated light fluxes having mutually different wavelengths for the same sample, the varying intensity of diffracted light is detected separately for each of the collimated light fluxes of the respective wavelengths, and the detection results are used selectively to evaluate the characteristics of the particles and/or medium.

2. The method for optical measurement according to claim 1, wherein the multiple collimated light fluxes are illuminated sequentially to the same sample at time intervals to detect diffracted light.

3. The method for optical measurement according to claim 1, wherein the multiple collimated light fluxes are illuminated simultaneously to the same sample on the same optical axis and diffracted light having the respective wavelengths are detected simultaneously at mutually different positions.

4. The method for optical measurement according to claim 1, wherein information about the diffusion coefficient or size of the particles or information about the viscosity of the medium is obtained from the temporal change of the diffracted light in the process of extinction of the diffraction grating.

5. The method for optical measurement according to claim 1, wherein information about the attraction of the particles is obtained from the temporal change of the diffracted light in the process of generation of the diffraction grating.

6. The method for optical measurement according to claim 1, wherein the size of the particles is given and information about the viscosity of the medium is obtained from the temporal change of the diffracted light in the process of extinction of the diffraction grating.

7. The method for optical measurement according to claim 1, wherein the measurement of the diffracted light is preceded by measuring the transmittance of multiple light having mutually different wavelengths with the particles being dispersed uniformly in the medium and obtaining a wavelength range suitable for detection of the diffracted light from the measured transmittance, and then the diffracted light is measured within the wavelength range.

8. The method for optical measurement according to claim 1, wherein among the detection results of the temporal change of the diffracted light by the multiple collimated light fluxes having mutually different wavelengths, detection results not affected by a plasmon resonance phenomenon on the particles are used selectively to evaluate the characteristics of the particles and/or medium.

9. An apparatus for optical measurement comprising: a cuvette for storing therein a sample having particles dispersed movably in a medium; a power source for generating an AC or DC voltage; an electrode pair adapted to generate a spatially periodic electric field in the cuvette through the application of the voltage from the power source; an irradiation optical system for irradiating a collimated light flux to a diffraction grating resulting from the density distribution of the particles generated in the cuvette through the application of the voltage; a detection optical system for detecting diffracted light generated by the collimated light flux transmitting through the diffraction grating; voltage control means for applying the voltage from the power source to the electrode pair and stopping or modulating the application of the voltage to generate and extinction the diffraction grating resulting from the density distribution of the particles in the cuvette; and data processing means for retrieving outputs from the detection optical system to evaluate the characteristics of the particles and/or medium, wherein
the irradiation optical system is adapted to selectively radiate multiple collimated light fluxes having mutually different wavelength ranges and the data processing means is adapted to retrieve detection outputs of diffracted light from the diffraction grating by the collimated light fluxes of the respective wavelength ranges.

10. The apparatus for optical measurement according to claim 9, wherein the irradiation optical system comprises: multiple lasers or LEDs for radiating, respectively, monochromatic light having mutually different wavelengths; and a collimation optical system for shaping the radiated light from the light sources into a collimated light flux.

11. The apparatus for optical measurement according to claim 9, wherein the irradiation optical system comprises: a light source for radiating light having a wide wavelength range; a wavelength selection optical system for selectively extracting multiple monochromatic light having mutually different wavelengths from the radiated light from the light source using a wavelength-dispersive spectroscope or multiple selectable interference filters; and a collimation optical system for shaping the extracted monochromatic light into a collimated light flux.

12. An apparatus for optical measurement comprising: a cuvette for storing therein a sample having particles dispersed movably in a medium; a power source for generating an AC or DC voltage; an electrode pair adapted to generate a spatially periodic electric field in the vessel through the application of the voltage from the power source; an irradiation optical system for irradiating a collimated light flux to a diffraction grating resulting from the density distribution of the particles generated in the cuvette through the application of the voltage; a detection optical system for detecting diffracted light generated by the collimated light flux transmitting through the diffraction grating; voltage control means for applying the voltage from the power source to the electrode pair and stopping or modulating the application of the voltage to generate and extinct the diffraction grating resulting from the density distribution of the particles in the cuvette; and data processing means for retrieving outputs from the detection optical system to evaluate the characteristics of the particles and/or medium, wherein
the irradiation optical system is adapted to simultaneously radiate multiple collimated light fluxes having mutually different wavelength ranges, the detection optical system is adapted to simultaneously and separately detect diffracted light appearing at different angles when the collimated light fluxes transmit through the diffraction grating, and the data processing means is adapted to retrieve detection outputs of the diffracted light by the detection optical system.

13. The apparatus for optical measurement according to claim 12, wherein the irradiation optical system comprises: multiple lasers or LEDs for radiating, respectively, monochromatic light having mutually different wavelengths; an optical system for combining light fluxes from the light sources on an optical path; and a collimation optical system for shaping the combined light into a collimated light flux.

14. The apparatus for optical measurement according to claim 12, wherein the irradiation optical system comprises: an LED having multiple emission spectra; and a collimation optical system for shaping output light from the LED into a collimated light flux.

15. The apparatus for optical measurement according to claim 12, wherein the irradiation optical system comprises: a light source for radiating light having a wide wavelength range; and a collimation optical system for shaping the radiated light from the light source into a collimated light flux, and the detection optical system is arranged in such a manner that the disposed positions of a plurality of light detectors and/or the position of a field-limiting mask for each light detector can be adjusted so that diffracted light having the respective wavelength components from the diffraction grating is received at mutually different angles.

16. The apparatus for optical measurement according to claim 9, wherein the data processing means is adapted to selectively use detection results of diffracted light from the diffraction grating by the collimated light fluxes of the respective wavelength ranges to obtain information about the diffusion coefficient or size of the particles or information about the viscosity of the medium.

17. The apparatus for optical measurement according to claim 9, further comprising: transmittance measuring means for measuring the transmittance of multiple light having mutually different wavelengths with the particles being dispersed uniformly in the medium before the measurement of the diffracted light; and wavelength selecting means for automatically determining multiple wavelengths of collimated light fluxes to be radiated from the irradiation optical system based on the measurement results and a preliminarily stored database.

18. The apparatus for optical measurement according to claim 12, wherein the data processing means is adapted to selectively use detection results of diffracted light from the diffraction grating by the collimated light fluxes of the respective wavelength ranges to obtain information about the diffusion coefficient or size of the particles or information about the viscosity of the medium.

19. The apparatus for optical measurement according to claim 12, further comprising: transmittance measuring means for measuring the transmittance of multiple light having mutually different wavelengths with the particles being dispersed uniformly in the medium before the measurement of the diffracted light; and wavelength selecting means for automatically determining multiple wavelengths of collimated light fluxes to be radiated from the irradiation optical system based on the measurement results and a preliminarily stored database.
